(19) United States
(12) Patent Application Publication
(10) Pub. No.: US 2007/0194726 A1
(43) Pub. Date: Aug. 23, 2007

(54) LAMP DRIVING APPARATUS AND LIQUID CRYSTAL DISPLAY INCLUDING THE SAME

(75) Inventors: Eui-dong HWANG, Incheon Metropolitan City (KR); Moon-shik KANG, Seongnam-si (KR); Dal-jung KWON, Seoul (KR); Jae-seok GHO, Cheonan-si (KR); Young-sup KWON, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si, Gyeonggi-do (KR)

(21) Appl. No.: 11/677,247

(22) Filed: Feb. 21, 2007

(30) Foreign Application Priority Data
Feb. 21, 2006 (KR) 10-2006-0016886

(51) Int. Cl. H05B 39/00

(52) U.S. Cl. 315/312

(57) ABSTRACT

A lamp driving apparatus includes a lamp driving unit which is provided with a predetermined direct current (“DC”) voltage from an external source, converts the provided DC voltage into a first lamp driving voltage and a second lamp driving voltage, and provides the first lamp driving voltage and the second lamp driving voltage to a lamp, and a control unit which detects the first lamp driving voltage and the second lamp driving voltage and generates first detection signals based on the detected first lamp driving voltage and generates second detection signals based on the detected second lamp driving voltage, compares a test signal with a reference voltage, and generates a driving control signal according to the result of the comparison, wherein the test signal is obtained by merging the first detection signal and the second detection signal.

This application claims priority to Korean Patent Application No. 10-2006-0016886, filed on Feb. 21, 2006, and all the benefits accruing therefrom under 35 U.S.C. §119, the contents of which in its entirety are herein incorporated by reference.

### BACKGROUND OF THE INVENTION

1. Field of the Invention

The present invention relates to a lamp driving apparatus and a liquid crystal display (“LCD”) including the same, and, more particularly, to a lamp driving apparatus whose structure is simplified by a reducing the number of elements and an LCD including the same.

2. Description of the Related Art

Recently, liquid crystal displays (“LCDs”) have been widely used as new display means in TVs, computer monitors, cameras, videos, and cellular phones. LCDs are light receiving display devices which receive light from an external source and modify that light to display images.

In LCDs, light is irradiated by a backlight assembly at the back of the LCD. The backlight assembly uses a lamp as a light source and converts light generated by the lamp into planar light and irradiates the same on a liquid crystal panel. In the case of computer monitors or TVs, a backlight assembly having high luminance is required. To meet this requirement, a backlight assembly using a plurality of lamps has been developed and a protection circuit is included in a lamp driving apparatus to remove risk of an abnormality in the output of the lamps.

The protection circuit includes a detection unit for detecting an abnormal signal generated by an abnormal state of the lamps and a comparison unit for comparing the detected abnormal signal with a reference voltage and generating a driving control signal for controlling the lamp driving apparatus.

Since the protection circuit detects an abnormal signal generated by an open or short condition in a lamp, and compares the abnormal signal with a reference voltage, a large number of elements are required, resulting in a complex circuit structure, and thus an increase in the manufacturing cost of the lamp driving circuit.

### BRIEF SUMMARY OF THE INVENTION

The present invention provides a lamp driving apparatus whose structure is simplified by reducing the number of elements.

The present invention also provides a liquid crystal display (“LCD”) including the lamp driving apparatus.

These and other aspects of the present invention will be described and become apparent in the following description of the exemplary embodiments.

According to an exemplary embodiment of the present invention, there is provided a lamp driving apparatus including a lamp driving unit provided with a direct current (“DC”) voltage from an external source, wherein the lamp driving unit converts the provided DC voltage into a first lamp driving voltage and a second lamp driving voltage and provides the first lamp driving voltage and the second lamp driving voltage to a lamp and a control unit which detects the first lamp driving voltage and the second lamp driving voltage and generates first detection signals based on the detected first lamp driving voltage and generates second detection signals based on the detected second lamp driving voltage, compares a test signal with a reference voltage, and generates a driving control signal according to a result of the comparison, wherein the test signal is obtained by merging the first detection signal and the second detection signal.

According to another exemplary embodiment of the present invention, there is provided a lamp driving apparatus including a lamp driving unit which is provided with a direct current (“DC”) voltage from an external source, converts the provided DC voltage into a plurality of lamp driving voltages, and provides the plurality of lamp driving voltages to a plurality of lamps, and a control unit which detects the plurality of lamp driving voltages and generates a plurality of detection signals based on the detected lamp driving voltages, compares a test signal with a reference voltage, and generates a driving control signal according to a result of the comparison, wherein the test signal is obtained by merging the plurality of detection signals.

According to still another aspect of the present invention, there is provided a liquid crystal display (“LCD”) including a lamp, a lamp driving apparatus including a lamp driving unit provided with a direct current (“DC”) voltage from an external source, wherein the lamp driving unit converts the provided DC voltage into a first lamp driving voltage and a second lamp driving voltage and provides the first lamp driving voltage and the second lamp driving voltage to a lamp and a control unit which detects the first lamp driving voltage and the second lamp driving voltage and generates first detection signals based on the detected first lamp driving voltage and generates second detection signals based on the detected second lamp driving voltage, compares a test signal with a reference voltage, and generates a driving control signal according to a result of the comparison, wherein the test signal is obtained by merging the first detection signal and the second detection signal, and a liquid crystal panel.

According to still another aspect of the present invention, there is provided a liquid crystal display (“LCD”) including a plurality of lamps, a lamp driving apparatus including a lamp driving unit which is provided with a direct current (“DC”) voltage from an external source, converts the provided DC voltage into a plurality of lamp driving voltages, and provides the plurality of lamp driving voltages to a plurality of lamps, and a control unit which detects the plurality of lamp driving voltages and generates a plurality of detection signals based on the detected lamp driving voltages, compares a test signal with a reference voltage, and generates a driving control signal according to a result of the comparison, wherein the test signal is obtained by merging the plurality of detection signals, and a liquid crystal panel.

### BRIEF DESCRIPTION OF THE DRAWINGS

The above and other aspects, features and advantages of the present invention will become more apparent by describing in detail an exemplary embodiment thereof with reference to the attached drawings in which:

FIG. 1 is a block diagram of an exemplary embodiment of a lamp driving apparatus according to the present invention;

FIG. 2 is a block diagram of an exemplary embodiment of a control unit of FIG. 1;

FIG. 3A is an equivalent circuit schematic diagram of a portion of the exemplary embodiment of a lamp driving apparatus of FIG. 1;

FIG. 3B is an equivalent circuit schematic diagram of another portion of the exemplary embodiment of a lamp driving apparatus of FIG. 1;

FIG. 4 is a block diagram of another exemplary embodiment of a lamp driving apparatus according to the present invention;

FIG. 5 is a block diagram of an exemplary embodiment of a control unit of FIG. 4; and

FIG. 6 is an exploded perspective view of an exemplary embodiment of a liquid crystal display (“LCD”) using an exemplary embodiment of a lamp driving apparatus according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined; all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in detail with reference to the accompanying drawings.

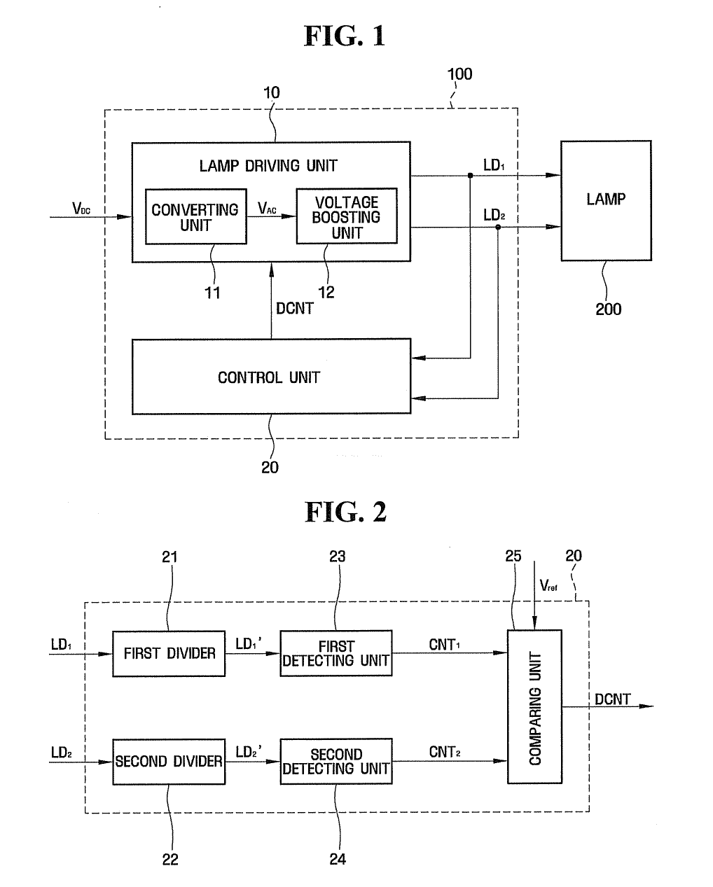

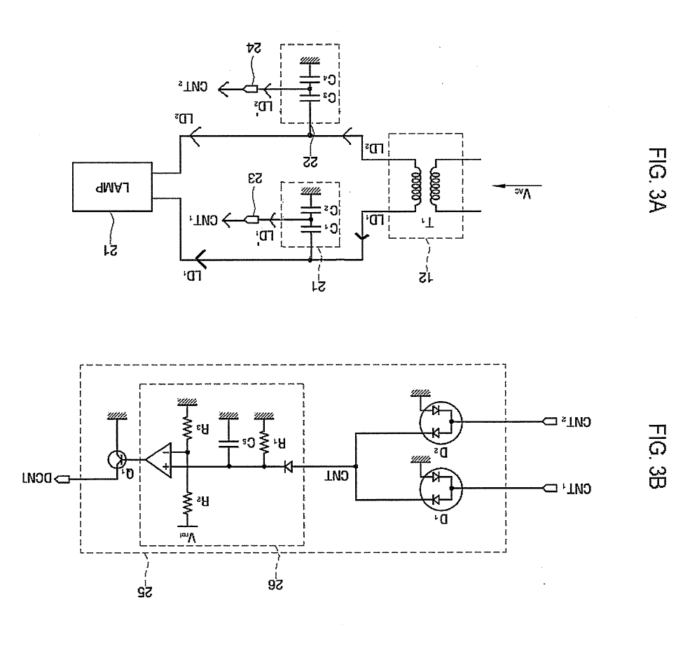

FIG. 1 is a block diagram of an exemplary embodiment of a lamp driving apparatus according to the present invention. FIG. 2 is a block diagram of an exemplary embodiment of a control unit of FIG. 1.

Referring to FIGS. 1 and 2, a lamp driving apparatus 100 includes a lamp driving unit 10 and a control unit 20. The lamp driving unit 10 includes a converting unit 11 and a voltage boosting unit 12. As shown in FIG. 2, the control unit 20 includes a first divider 21, a second divider 22, a first detecting unit 23, a second detecting unit 24, and a comparing unit 25.

The lamp driving unit 10 receives a predetermined direct current (“DC”) voltage V_{DC} from an external source and generates first and second lamp driving voltages LD₁ and LD₂ for driving a lamp 200.

The converting unit 11 converts the DC voltage V_{DC} into an alternating current (“AC”) voltage V_{AC}. The converting unit 11 may be, for example, a switching device such as a metal-oxide semiconductor field-effect transistor (“MOSFET”) which converts the DC voltage V_{DC} into the AC voltage V_{AC} through a switching operation.

The voltage boosting unit 12 boosts the AC voltage V_{AC} provided from the converting unit 11 to generate the first and second lamp driving voltages LD₁ and LD₂ for driving the lamp 200. The first lamp driving voltage LD₁ and the second lamp driving voltage LD₂ may be out of phase.

The control unit 20 receives the first and second lamp driving voltages LD₁ and LD₂ from the lamp driving unit 10, generates detection signals CNT₁ and CNT₂, and generates a predetermined driving control signal DCNT based on the detection signals CNT1 and CNT2. The driving control signal DCNT is fed back to the lamp driving unit 10 to control an operation of the lamp driving unit 10. Hereinafter, an operation of the lamp driving apparatus 100 will be described in greater detail with reference to FIGS. 1-2 and FIGS. 3A and 3B.

FIG. 3A is a circuit schematic diagram of a portion of the exemplary embodiment of a lamp driving apparatus of FIG. 1 and FIG. 3B is an equivalent circuit schematic diagram of another portion of the exemplary embodiment of a lamp driving apparatus of FIG. 1.

First, the lamp driving unit 10 receives the DC voltage V_{DC} from an external source and generates the first and second lamp driving voltages LD₁ and LD₂ for driving the lamp 200. Specifically, the converting unit 11 of the lamp driving unit 10 converts the input DC voltage V_{DC} into the AC voltage V_{AC} and the voltage boosting unit 12 boosts the AC voltage V_{AC} to generate the first and second lamp driving voltages LD₁ and LD₂ as described above. In one exemplary embodiment the voltage boosting unit 12 may be a transformer T1 as shown in FIG. 3A. The first and second lamp driving voltages LD₁ and LD₂ may be out of phase as mentioned above.

As shown in FIGS. 1, 2 and 3A the first lamp driving voltage LD₁ generated by the lamp driving unit 10 is input to the first divider 21 of the control unit 20 and the first divider 21 divides the first lamp driving voltage LD₁. The first detecting unit 23 generates the first detection signal CNT₁ from the divided first lamp driving voltage LD1′. Here, when a failure, such as an open or short in a lamp, occurs in the lamp driving apparatus 100, the amplitude of the first lamp driving voltage LD₁ input to the first divider 21 increases, causing an increase in the amplitude of the first detection signal CNT₁.

Similarly, as shown in FIGS. 1, 2 and 3A, the second lamp driving voltage LD₂ generated by the lamp driving unit 10 is input to the second divider 22 of the control unit 20 and the second divider 22 divides the second lamp driving voltage LD₂. At this time, the second detecting unit 24 generates the second detection signal CNT₂ from the divided second lamp driving voltage LD₂′. Like the first detection signal CNT₁, when a failure, such as an open or short of a lamp, occurs in the lamp driving apparatus 100, the amplitude of the second lamp driving voltage LD₂ input to the second divider 22 increases, causing an increase in the amplitude of the second detection signal CNT₂.

Here, the first divider 21 may comprise a pair of capacitors C₁ and C₂ and the second divider 22 may comprise a pair of capacitors C₃ and C₄. In one exemplary embodiment the first divider 21 is composed of the two capacitors C₁ and C₂ connected in parallel to the first lamp driving voltage LD₁ and the second divider 22 is composed of the two capacitors C₃ and C₄ connected in parallel to the second lamp driving voltage LD₂. The capacitors C₁, C₂, C₃, and C₄ remove small fluctuations (e.g., ripple) from the input first and second lamp driving voltages LD₁ and LD₂ and divide the input first and second lamp driving voltages LD₁ and LD₂ into predetermined voltages.

As described above and as shown in FIGS. 1, 2 and 3B, the first detection signal CNT₁ generated by the first detecting unit 23 and the second detection signal CNT₂ generated by the second detecting unit 24 are input to the comparing unit 25. The comparing unit 25 merges the first detection signal CNT1 and the second detection signal CNT₂ into a single test signal CNT. Diodes D₁ and D₂ shown in FIG. 3B serve as a single load and prevent an over-voltage or an over-current from being generated by the first detection signal CNT₁ and the second detection signal CNT₂.

As shown in FIG. 3B, the test signal CNT is compared with a predetermined reference voltage Vref and a predetermined driving control signal DCNT is generated according to the result of the comparison. The test signal CNT is provided as an input to a comparator 26, which comprises a plurality of resistors R₁, R₂, and R₃ and a capacitor C₅, and the comparator 26 compares the test signal CNT with the predetermined reference voltage Vref. A predetermined signal passing through the comparator 26 is provided as an input to a switching element Q₁ and the switching element Q₁ generates the driving control signal DCNT according to whether a signal is input. The driving control signal DCNT is fed back to the lamp driving unit 10 to control the operation of the lamp driving unit 10.

Hereinafter, the operation of the control unit 20 will be described in more detail.

If any one of the first detection signal CNT₁ and the second detection signal CNT₂ is an abnormal signal, for example, a signal whose amplitude is increased due to a failure in the lamp driving apparatus 100 as mentioned above, the amplitude of the test signal CNT also increases. The test signal CNT is compared with the predetermined reference voltage Vref and the comparing unit 25 generates the driving control signal DCNT if the test signal CNT is equal to or greater than the reference voltage Vref. The generated driving control signal DCNT is provided to the lamp driving unit 10 to stop the operation of the lamp driving unit 10.

Similarly, if the first detection signal CNT₁ and the second detection signal CNT₂ are normal signals, e.g., they have the same amplitude as the predetermined reference voltage Vref, the test signal CNT also will be normal, and if the test signal CNT is less than the reference voltage Vref, the comparing unit 25 does not generate the driving control signal DCNT.

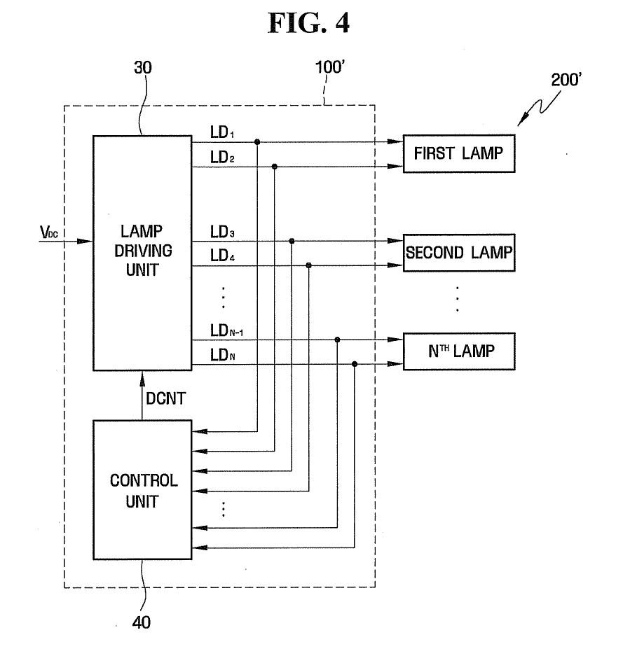

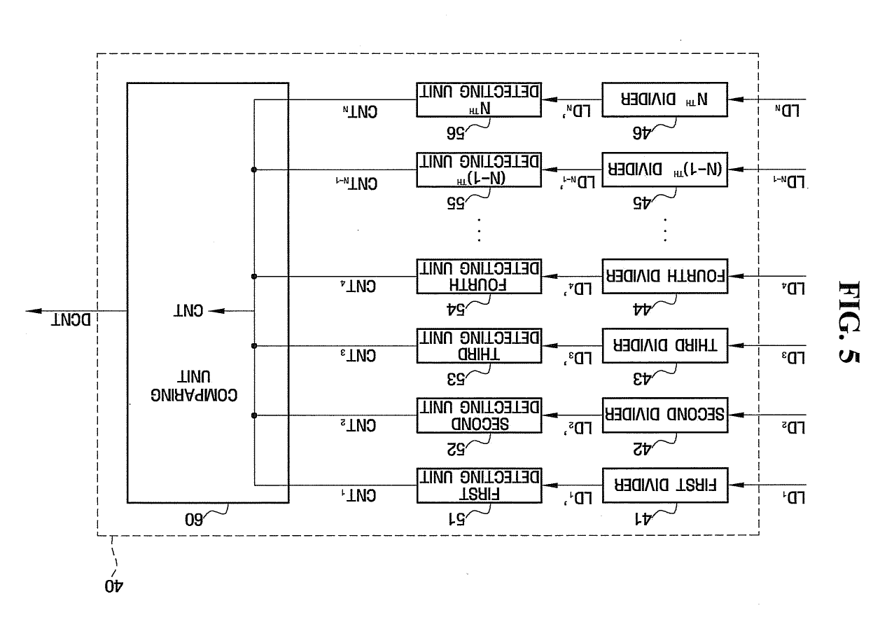

Hereinafter, another exemplary embodiment of a lamp driving apparatus 100′ according to the present invention will be described with reference to FIGS. 4 and 5.

FIG. 4 is a block diagram of another exemplary embodiment of a lamp driving apparatus according to the present invention, and FIG. 5 is a block diagram of an exemplary embodiment of a control unit of FIG. 4.

Referring to FIGS. 4 and 5, the lamp driving apparatus 100′ includes a lamp driving unit 30 and a control unit 40.

The lamp driving unit 30 generates a plurality of lamp driving voltages LD₁, LD₂, LD₃, LD₄, . . . , LD_{N-1}, LD_{N} capable of driving a plurality of first through N^{TH} lamps 200′. The lamp driving unit 30 includes a converting unit (not shown) and a voltage boosting unit (not shown) similar to those described above. The converting unit converts the DC voltage V_{DC} into the AC voltage V_{AC} and the voltage boosting unit generates the lamp driving voltages LD₁, LD₂, LD₃, LD₄, . . . , LD_{N-1}, LD_{N} driving the plurality of lamps 200′ based on the AC voltage V_{AC}. The number of voltage boosting units may be proportional to the number of lamp driving voltages LD₁, LD₂, LD₃, LD₄, . . . , LD_{N-1}, LD_{N}.

The control unit 40 includes a plurality of first through nth dividers 41 through 46, a plurality of first through nth detecting units 51 through 56, and a comparing unit 60. The dividers 41 through 46 output the lamp driving voltages LD₁′, LD₂′, LD₃′, LD₄′, . . . , LD_{N-1}′, LD_{N}′ which are obtained by dividing the lamp driving voltages LD₁, LD₂, LD₃, LD₄, . . . , LD_{N-1}, LD_{N}. The lamp driving voltages LD₁40 , LD₂′, LD₃′, LD₄′, . . . , LD_{N-1}′, LD_{N}′ output by the dividers 41 through 46 are provided to the detecting units 51 through 56, which generate detection signals CNT₁, CNT₂, CNT₃, CNT₄, . . . , CNT_{N-1}, CNT_{N}. The comparing unit 60 merges the detection signals CNT₁, CNT₂, CNT₃, CNT₄, . . . , CNT_{N-1}, CNT_{N} into a single test signal CNT₁ compares the test signal CNT with the predetermined reference voltage Vref (not shown), and generates the driving control signal DCNT according to the result of the comparison.

In one exemplary embodiment each of the dividers 41 through 46 is composed of a pair of capacitors connected in parallel to each of the lamp driving voltages LD₁, LD₂, LD₃, LD₄, . . . , LD_{N-1}, LD_{N} and the capacitors remove small fluctuations of the lamp driving voltages LD₁, LD₂, LD₃, LD₄, . . . , LD_{N-1}, LD_{N} and divide the lamp driving voltages LD₁, LD₂, LD₃, LD₄, . . . , LD_{N-1}, LD_{N} into predetermined voltages.

The control unit 40 is provided with the lamp driving voltages LD₁, LD₂, LD₃, LD₄, . . . , LD_{N-1}, LD_{N} from the lamp driving unit 30 to generate the detection signals CNT₁, CNT₂, CNT₃, CNT₄, . . . , CNT_{N-1}, CNT_{N}. The control unit 40 generates the driving control signal DCNT based on the detection signals CNT₁, CNT₂, CNT₃, CNT₄, . . . , CNT_{N-1}, CNT_{N}. The generated driving control signal DCNT is fed back to the lamp driving unit 30 to control the operation of the lamp driving unit 30.

If any one of the detection signals CNT₁, CNT₂, CNT₃, CNT₄, . . . , CNT_{N-1}, CNT_{N} is an abnormal signal, for example, a signal whose amplitude is increased due to a failure in the lamp driving apparatus 100′, the amplitude of the test signal CNT also increases. The test signal CNT is compared with the predetermined reference voltage and the comparing unit 60 generates the driving control signal DCNT if the test signal CNT is equal to or greater than the reference voltage. The generated driving control signal DCNT is provided to the lamp driving unit 30 to stop the operation of the lamp driving unit 30.

Similarly, if the detection signals CNT₁, CNT₂, CNT₃, CNT₄, . . . , CNT_{N-1}, CNT_{N} are all normal signals, the test signal CNT is also generated as a normal signal. If the test signal CNT is less than the reference voltage, the comparing unit 60 does not generate the driving control signal DCNT and the operation of the lamp driving unit is not stopped.

Since the comparing unit 60 obtains the single test signal CNT by merging the plurality of detection signals CNT₁, CNT₂, CNT₃, CNT₄, . . . , CNT_{N-1}, CNT_{N}, only a single comparator is required, thereby reducing the number of elements of the lamp driving apparatus 100′ and simplifying the structure of the lamp driving apparatus 100′.

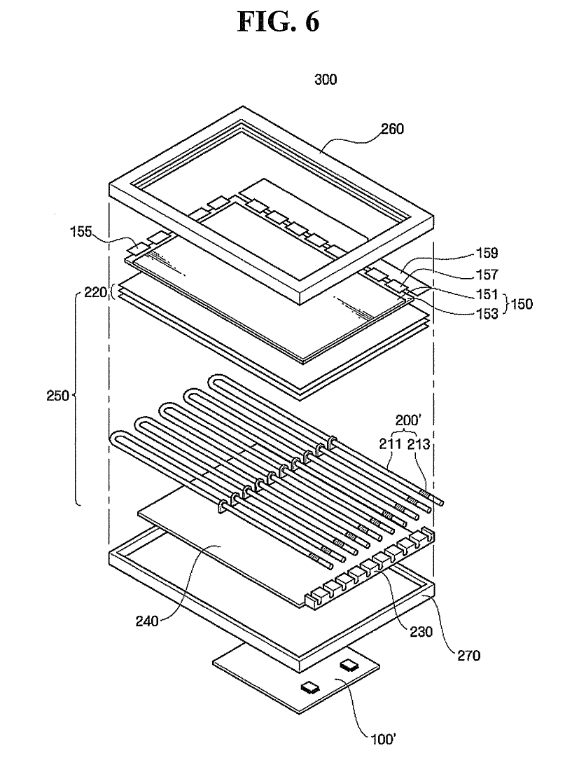

Hereinafter, a liquid crystal display (“LCD”) 300 using either of the exemplary embodiments of a lamp driving apparatus shown in FIGS. 1 through 5 will be described in detail with reference to FIG. 6.

FIG. 6 is an exploded perspective view of an exemplary embodiment of a liquid crystal display (“LCD”) using an exemplary embodiment of a lamp driving apparatus according to the present invention. For explanatory convenience and clarity, an exemplary embodiment of an LCD using the exemplary embodiment of a lamp driving apparatus shown in FIG. 4 will be described.

Referring to FIG. 6, the LCD 300 includes a liquid crystal panel 150, a backlight assembly 250, a top receiving container 260 and a bottom receiving container 270 receiving the liquid crystal panel 150 and the backlight assembly 250, and the lamp driving apparatus 100′.

The liquid crystal panel 150 displays an image and includes a first substrate 153, a second substrate 151, and a liquid crystal layer (not shown) therebetween.

In one exemplary embodiment the first substrate 153 includes a plurality of gate lines extending in a first direction at predetermined intervals, a plurality of data lines arranged at predetermined intervals and extending in a second direction to intersect the gate lines, pixel electrodes arranged in a matrix form in a pixel region defined by the gate lines and the data lines, and thin film transistors (“TFTs”) switched on and off by a signal of the gate lines to transmit a signal of the data lines to each of the pixel electrodes.

In one exemplary embodiment a light blocking pattern for blocking light not applied to the pixel region, an RGB color filter pattern for expressing colors, and a common electrode are formed in the second substrate 151.

The first substrate 153 and the second substrate 151 are bonded together with a spacer having a predetermined interval.

A liquid crystal layer (not shown) having optical anisotropy is formed between the first substrate 153 and the second substrate 151. The liquid crystal layer either blocks light or allows light to pass through it depending on a state of an electric field between the common electrode of the second substrate 151 and the pixel electrode of the first substrate 153.

A printed circuit board (“PCB”) 159 is electrically connected to one side of the liquid crystal panel 150 by tape carrier packages (“TCPs”) 155 and 157. A driving integrated circuit (“IC”) for driving the liquid crystal panel 150 is mounted in the center of the TCPs 155 and 157. The PCB 159 and the TCPs 155 and 157 apply a driving signal and a timing signal to the gate lines and the data lines of the first substrate 153 to control the timing and arrangement of movements of liquid crystals in the liquid crystal layer.

The backlight assembly 250 is positioned under the liquid crystal panel 150 to provide light to the liquid crystal panel 150.

The backlight assembly 250 includes lamps 200′, a lamp holder 230, optical sheets 220, and a reflecting sheet 240.

The lamps 200′ are positioned under the liquid crystal panel 150 and provide light to the liquid crystal panel 150. The lamps 200′ include a plurality of lamp tubes 211 which are U-shaped and a plurality of external electrodes 213 formed at an end of the lamp tubes 211. A discharging gas is injected into the lamp tubes 211 and the external electrodes 213 are made of a conductive material to surround the exterior of the lamp tubes 211. The lamps 200′ generate light using a lamp driving voltage applied from the lamp driving apparatus 100′ to the external electrodes 213 of the lamps 200′.

The lamps 200′, which in this exemplary embodiment are spaced equidistant from each other, are coplanar to be connected in parallel with the rest of the direct-type backlight assembly. Direct-type backlight assemblies directly irradiate the entire surface of the liquid crystal panel 150. Therefore, a light guide plate typically used for an edge-type backlight assembly is not necessary. However, alternative exemplary embodiments include configurations where the lamp driving apparatus of the present invention is applied to edge-type backlight assemblies.

The lamps 200′ may be a linear light source such as a cold cathode fluorescent lamp (“CCFL”) or a hot cathode fluorescent lamp (“HCFL”). In addition, the lamps 200′ may be internal electrode fluorescent lamps or external electrode fluorescent lamps according to the position of the electrode. The current exemplary embodiment of the present invention will be described as using external electrode fluorescent lamps formed at both ends of the U-shaped lamp section.

The lamp holder 230 is positioned at one end of the lamps 200′ to support and fix them in place. The lamp holder 230 includes a voltage applying means (not shown) for applying the lamp driving voltage provided from the lamp driving apparatus 100′ to the external electrodes 213 of the lamps 200′.

The reflecting sheet 240 is positioned under the lamps 200′. The reflecting sheet 240 reflects light emitted from the under side of the lamps 200′ to increase the luminance of the backlight assembly 250 and cause light to be uniformly irradiated to the liquid crystal panel 150.

The reflective sheet 240 may be made of a thin, highly elastic and reflective material; exemplary embodiments of the reflective sheet 240 may be an about 0.01 mm to about 5 mm thick polyethylene terephthalate (“PET”) sheet. Alternative exemplary embodiments of the reflective sheet 240 may be further provided with a reflective layer coated on a thin, highly elastic material.

The optical sheets 220 are arranged on the lamps 200′. The optical sheets 220 allow light transmitted from the lamps 200′ to be uniformly irradiated towards the liquid crystal panel 150. The optical sheets 220 are made by positioning at least one optical sheet, exemplary embodiments of which include a diffusion sheet, prism sheet, or protection sheet, on the lamps 200′. Exemplary embodiment include configurations where only a single optical sheet is used or where multiple optical sheets of the same type are used. The stacking order of the optical sheets may be varied to improve the uniformity of the light being emitted. Exemplary embodiments of the optical sheets 220 may be formed of transparent resin such as acryl resin, polyurethane resin, or silicon resin.

The bottom receiving container 270 is disposed below the backlight assembly 250 and receives and supports the components of the backlight assembly 250. In the current exemplary embodiment the bottom receiving container 270 has the shape of a rectangular parallelepiped with an open top surface, however alternative exemplary embodiments include varying configurations. Exemplary embodiments of the bottom receiving container 270 may be made of an insulating synthetic resin. In addition, a supporting portion (not shown) is formed inside the bottom receiving container 270 to seat the liquid crystal panel 150. The top receiving container 260 is coupled to the bottom receiving container 270, and contains the liquid crystal panel 150 and the back light assembly 250. Exemplary embodiments of the top receiving container 260 may be formed of a metal such as aluminum (Al) or Al alloy.

In addition, the top receiving container 260 can be coupled to the bottom receiving container 270. Exemplary embodiments of the coupling method include using hooks. In one exemplary embodiment a hook (not shown) may be formed along an outer side of the sidewall of the top receiving container 260, and a hook insertion hole (not shown) with a location corresponding to the location of the hook may be formed at a side of the bottom receiving container 270. Thus, the bottom receiving container 270 extends up from the lower portion of the top receiving container 260 so that the hook formed in the top receiving container 260 is inserted into the hook insertion hole of the bottom receiving container 270, and the top receiving container 260 and the bottom receiving container 270 are combined. Alternative exemplary embodiments include configurations where the hook may be located in the bottom receiving container 270, and the hook insertion hole may be formed in the top receiving container 260. Alternative exemplary embodiments include the configuration where the top receiving container 260 and the bottom receiving container 270 are coupled to each other in various manners.

As described above, exemplary embodiments of the lamp driving apparatus and an LCD including the same of the present invention according to the present invention provide at least the following advantages.

First, an LCD can be protected by turning off a lamp driving apparatus if any one of a plurality of lamps of the LCD operates abnormally.

Second, by reducing the number of elements of a lamp driving apparatus, a circuit structure can be simplified.

Third, the manufacturing cost of the lamp driving apparatus can be reduced.

While the present invention has been particularly shown and described with reference to exemplary embodiments thereof, it will be apparent to those skilled in the art that the scope of the invention is given by the appended claims, rather than the preceding description, and all variations and equivalents which fall within the range of the claims are intended to be embraced therein. Therefore, it should be understood that the above embodiments are not limitative, but illustrative in all aspects.

What is claimed is:

1. A lamp driving apparatus comprising:
a lamp driving unit which is provided with a direct current voltage from an external source, wherein the lamp driving unit converts the provided direct current voltage into a first lamp driving voltage and a second lamp driving voltage and provides the first lamp driving voltage and the second lamp driving voltage to a lamp; and
a control unit which detects the first lamp driving voltage and the second lamp driving voltage and generates a first detection signal based on the detected first lamp driving voltage and generates a second detection signal based on the detected second lamp driving voltage, compares a test signal with a reference voltage, and generates a driving control signal according to a comparison result,
wherein the test signal is obtained by merging the first detection signal and the second detection signal.

2. The lamp driving apparatus of claim 1, wherein the control unit comprises:
a detecting unit including a first detecting unit which outputs a first detection signal based on the detected first lamp driving voltage and a second detecting unit which outputs a second detection signal based on the detected second lamp driving voltage; and
a comparing unit which generates the test signal by merging the first detection signal and the second detection signal, compares the test signal with the reference voltage, and generates the driving control signal according to the comparison result.

3. The lamp driving apparatus of claim 2, wherein the first detection signal is changed by an open or short condition in the lamp which is provided with the first lamp driving voltage.

4. The lamp driving apparatus of claim 2, wherein the second detection signal is changed by an open or short condition in the lamp which is provided with the second lamp driving voltage.

5. The lamp driving apparatus of claim 2, wherein the comparing unit generates the driving control signal if the voltage level of the test signal is greater than the reference voltage, and wherein the comparing unit does not generate the driving control signal if the voltage level of the test signal is less than the reference voltage.

6. The lamp driving apparatus of claim 5, wherein the driving control signal is fed back to the lamp driving unit to control the operation of the lamp driving unit.

7. The lamp driving apparatus of claim 2, wherein the first detecting unit and the second detecting unit include dividers for dividing the first lamp driving voltage and the second lamp driving voltage.

8. The lamp driving apparatus of claim 7, wherein each of the dividers includes a pair of capacitors.

9. The lamp driving apparatus of claim 1, wherein the lamp is U-shaped.

10. The lamp driving apparatus of claim 1, wherein the first lamp driving voltage and the second lamp driving voltage are alternating current voltages and the lamp driving unit further includes a converting unit for converting the direct current voltage from an external source into the alternating current voltage and a voltage boosting unit which generates the first lamp driving voltage and the second lamp driving voltage by boosting the alternating current voltage.

11. A lamp driving apparatus comprising:
a lamp driving unit which is provided with a direct current voltage from an external source, converts the provided direct current voltage into a plurality of lamp driving voltages, and provides the plurality of lamp driving voltages to a plurality of lamps; and
a control unit which detects the plurality of lamp driving voltages and generates a plurality of detection signals based on the detected lamp driving voltages, compares a test signal with a reference voltage, and generates a driving control signal according to a result of the comparison,
wherein the test signal is obtained by merging the plurality of detection signals.

12. The lamp driving apparatus of claim 11, wherein the control unit comprises:
a plurality of detecting units which output a detection signal based on each of the detected lamp driving voltages; and
a comparing unit which generates the test signal by merging the generated detection signals, compares the test signal with the reference voltage, and generates the driving control signal according to the result of the comparison.

13. The lamp driving apparatus of claim 12, wherein each of the detection signals are changed by an open or short condition in the lamp which is provided with the lamp driving voltages.

14. The lamp driving apparatus of claim 12, wherein the comparing unit generates the driving control signal if the voltage level of the test signal is greater than the voltage level of the reference voltage, and wherein the comparing unit does not generate the driving control signal if the voltage level of the test signal is less than the voltage level of the reference voltage.

15. The lamp driving apparatus of claim 14, wherein the driving control signal is fed back to the lamp driving unit to control the operation of the lamp driving unit.

16. The lamp driving apparatus of claim 12, wherein the plurality of detecting units include dividers for dividing each of the lamp driving voltages.

17. The lamp driving apparatus of claim 16, wherein each of the dividers includes a pair of capacitors.

18. The lamp driving apparatus of claim 11, wherein the lamp is U-shaped.

19. The lamp driving apparatus of claim 11, wherein the lamp driving voltages are alternating current voltages and the lamp driving unit further includes a converting unit for converting the direct current voltage into the alternating current voltage and a voltage boosting unit which generates the plurality of lamp driving voltages by boosting the alternating current voltage.

20. A liquid crystal display comprising:
a lamp;
a lamp driving apparatus comprising;
a lamp driving unit which is provided with a direct current voltage from an external source, converts the provided direct current voltage into a first lamp driving voltage and a second lamp driving voltage, and provides the first lamp driving voltage and the second lamp driving voltage to the lamp, and a control unit which detects the first lamp driving voltage and the second lamp driving voltage and generates first detection signals based on the detected first lamp driving voltage and generates second detection signals based on the detected second lamp driving voltage, compares a test signal with a reference voltage, and generates a driving control signal according to a result of the comparison, wherein the test signal is obtained by merging the first detection signal and the second detection signal; and
a liquid crystal panel.

21. A liquid crystal display comprising:
a plurality of lamps;
a lamp driving apparatus comprising;
a lamp driving unit which is provided with a direct current voltage from an external source, converts the provided direct current voltage into a plurality of lamp driving voltages, and provides the plurality of lamp driving voltages to the plurality of lamps, and a control unit which detects the plurality of lamp driving voltages and generates a plurality of detection signals based on the detected lamp driving voltages, compares a test signal with a reference voltage, and generates a driving control signal according to a result of the comparison, wherein the test signal is obtained by merging the plurality of detection signals; and
a liquid crystal panel.
